(19) United States
(12) Patent Application Publication
(10) Pub. No.: US 2026/0320269 A1
(43) Pub. Date: Oct. 15, 2026

(54) CUSTOMIZABLE AND MIGRATABLE IP DESIGN METHOD AND SYSTEM

(71) Applicant: Hong Kong Applied Science and Technology Research Institute Company Limited, Shatin (HK)

(72) Inventors: Yuan LEI, Shenzhen (CN); Shunqi DAI, Kowloon (HK); Chenyue MA, MA ON SHAN (HK)

(73) Assignee: Hong Kong Applied Science and Technology Research Institute Company Limited, Shatin (HK)

(21) Appl. No.: 19/068,255

(22) Filed: Mar. 3, 2025

(51) Int. Cl. G06F 30/327; G06F 30/31; G06F 30/323; G06F 30/392; G06F 115/08

(52) U.S. Cl. CPC G06F 30/327; G06F 30/31; G06F 30/323; G06F 30/392; G06F 2115/08

(57) ABSTRACT

A method and device for designing an integrated circuit integrating intellectual property modules. A platform-neutral technology synthesis module uses a circuit topology expertise module, a schematic expertise module, and a layout expertise module to process a specification using a particular process design kit to produce a final integrated circuit design. A device which implements the method and produces a final integrated circuit design file is also disclosed.

### BACKGROUND OF THE INVENTION

### 1. Field of the Invention

Aspects of the invention relate to a novel IP design approach that is fully automated, customizable and migratable while preserving and reusing design expertise.

### 2. Description of the Related Art

Many integrated circuit (“IC”) intellectual property elements (“IP”) need to be redesigned from scratch when the process changes or design requirements change (e.g., Analog IP, RF IP and foundation IP). Current IP design methods include: 1) manual design, which is error-prone and time consuming because of iteration, and may take several months; and 2) more recently, Electronic Design Automation (“EDA”) has supported the design of IP through automated sizing and layout tools, but this design method requires the preparation of a large number of testbenches, settings, parameters and constraints for each design. Therefore, the IC industry struggles with: 1) lack of migratable and customizable design method; and 2) lack of effective method for knowledge transfer.

Technology has moved very quickly from 180 nanometer (“nm”) to 28nm or even lower channel lengths for IC. The need to constantly build smaller and faster circuits means that designers and electronic companies need to move their existing designs to the latest technology as quickly and efficiently as possible to avoid losing the opportunity to market their products and designs and to ensure that society benefits from advancements in technology as much as possible.

The main challenge with traditional custom IP design is that it needs to be redesigned for every process, and often the correct configuration is not available off-the-shelf, and so manual work is required to fit the design to the application.

Generally, transferring an old design to a new technology requires engineers to go through a long and tedious process. A company that has several design teams participating at multiple stages of the design process will therefore have to expend a large amount of time and resources for their teams to go through the design process from the start and keep them coordinated throughout.

This need for speed and resources cause tape-out delays or even chip failure. In addition, as manual work is often required, this can substantially increase the cost of the analog IP, either up front due to the engineering effort involved or later due to the analog circuitry failing and requiring a respin and/or the die area implications to the chip.

A method for IC IP design which addressed these requirements would be a useful invention. An apparatus for implementing such a method would also be a useful invention. Aspects of the present invention address these concerns.

This disclosure introduces a novel IP design approach that: 1) is customizable and migratable, not constrained by design specifications and semiconductor processes; 2) preserves and reuses existing design expertise; and 3) is fully automated.

### SUMMARY OF THE INVENTION

Aspects of the present invention include a method for designing IC integrating IP which is customizable and migratable without being constrained by design specifications and particular semiconductor manufacturing processes.

Aspects of the present invention further include a method for designing IC integrating IP which preserves and reuses existing design expertise.

Aspects of the invention further provide a method for designing IC integrating IP which is fully automated.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow diagram of an aspect of the invention.

FIG. 2 is an abstract block diagram of the elements of an aspect of the invention.

FIG. 3 is an abstract block diagram of the components of the expertise libraries.

FIG. 4 is an abstract schematic of a device for implementing the method of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

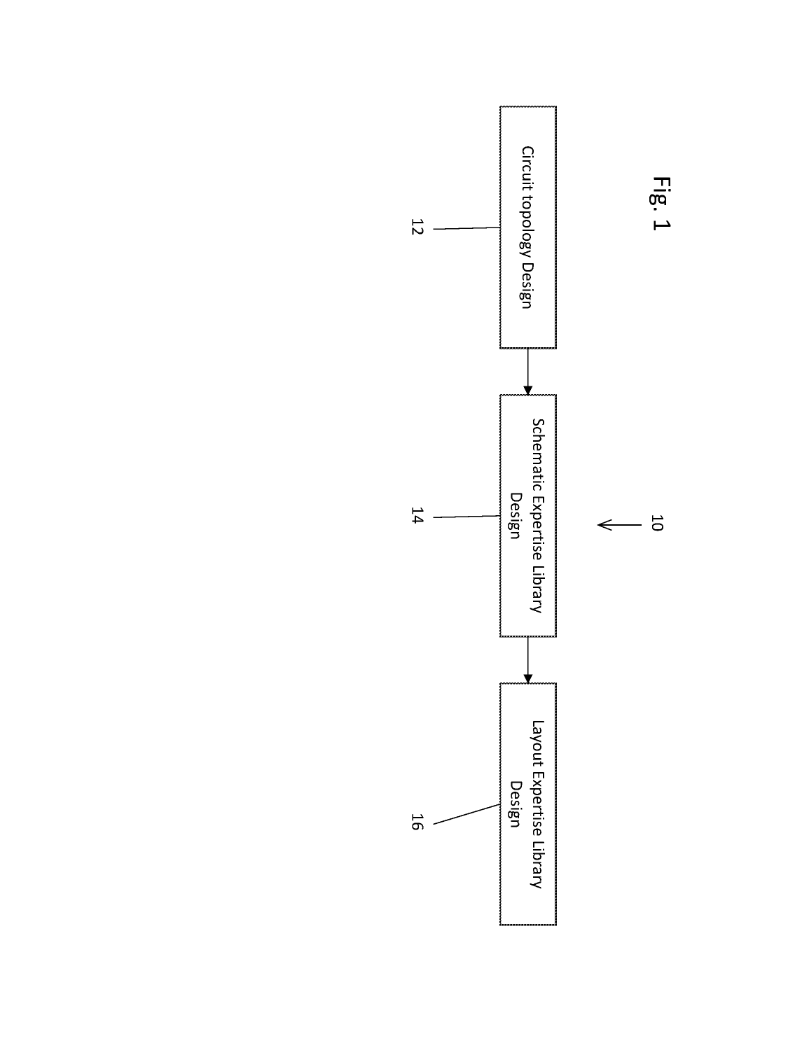

By referring to FIG. 1, a basic method according to an aspect of the invention can be understood. Flow diagram 10 shows three overall steps, which will be discussed in greater detail below, comprising this aspect of the invention, with the ultimate purpose of producing an IC design which will fulfill one or more target functions and can be produced in a designated IC production process. The designated production process will include such parameters as die size (typically in mm^2), element size (typically in nm), and the specific format for IC design parameters required by a designated production facility (or “foundry”) and/or a designated integrated circuit production line (or “forge”) which will actually create the dies and from the dies the desired IC.

First, a circuit topology design step (or “first step”) 12 comprises all the steps necessary to design the topology of the desired IC design. Second, schematic expertise library design step (or “second step”) 14 comprises all steps necessary to prepare a first set of inputs, including but not limited to test-benches, constraints, and settings required to run the auto-sizing tool for the circuit topology from the previous step. This first set of inputs, after refinement, is independent of the specification and the PDK for platform neutrality. Finally, layout expertise library design step (or “third step”) 16, comprises all steps necessary to prepare a second set of inputs including but not limited to as post-layout test-benches, layout constraints, and settings required to run the auto-layout tool for the sized schematic generated by the auto-sizing tool . This second set of inputs, after refinement, is independent of the specification and the PDK for platform neutrality.

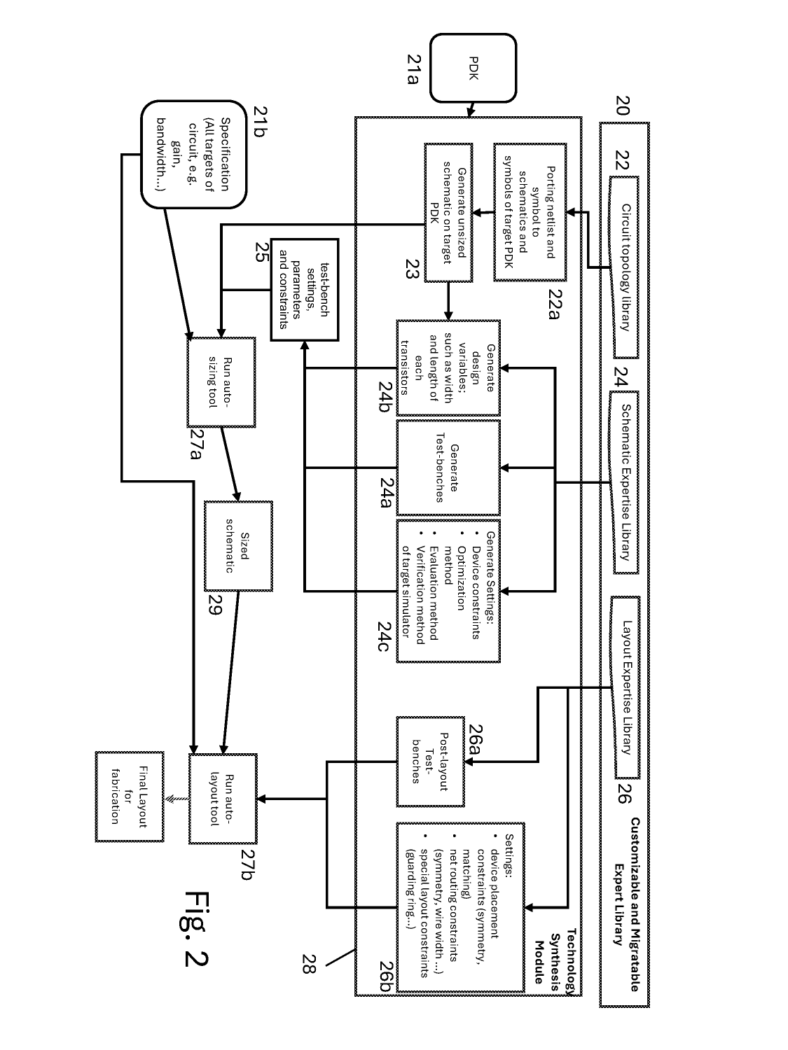

FIG. 2 shows the elements of each step in an aspect of the invention. Technology Synthesis Module (“TSM”) 28 contains the necessary components for instantiating the expertise libraries in combination with the specific PDK (see below) and particular specification (see below) associated with each of the steps shown in FIG. 1 for any given usage of the method. Customizable and Migratable IP System 20 (or merely “IP System 20”) includes Circuit Topology Expertise Library 22, Schematic Expertise Library 24, and Layout Expertise Library 26. The elements of IP System 20 are referenced by TSM 28 to practice the method of the invention.

To implement this aspect of the invention, a Process Design Kit (“PDK”) 21a corresponding to the design format requirements of the designated foundry/forge which will be producing the desired IC is obtained from a suitable source. Also, a specification 21b is produced which includes all desired functionality (e.g. circuit type, topology name associated with the detail topology in the circuit topology expertise library, targets of the circuit such as gain or phase margin, input parameters, output parameters, circuit and logic functionalities) of the IC to be designed by the method. These are referenced by TSM 28 and the method begins.

In first step 12, TSM 28 references PDK 21a to obtain the preferred format (schematic format, symbology, et cetera) of IC circuit design for the designated forge. TSM 28 then uses Circuit Topology Expertise Library 22 to port the netlist and symbology of specification 21b to the preferred format of the designated forge in substep 22a, generating unsized schematic 23.

In second step 14, TSM 28 references PDK 21a to obtain the preferred test-bench schematics of the designated forge and generate test-benches in substep 24a. TSM 28 then generates the general design parameters required for the designated forge in substep 24b. In substep 24c, TSM 28 sets the device constraints, optimization methods, the evaluation method for a desired auto-sizing tool, and the verification method of the target simulator for the IC to be designed by the method. The results of substeps 24a-24c are used to generate test-bench settings, parameters and constraints 25 for the IC to be designed by the method. In substep 27a, the desired auto-sizing tool is run on the unsized schematic 23 using test-bench settings, parameters and constraints 25 to generate sized schematic 29.

In third step 16, TSM 28 references layout expertise library 26 to perform substeps 26a-2b. In substep 26a, the test-bench schematics of substep 24a are re-used or, if necessary after substep 27a, are re-generated to reflect sized schematic 29. In substep 26b, the device placement constraints of a desired auto-layout tool are set according to the requirements of PDK 21a and the content of layout expertise library 26. Also in substep 26b, the device placement constraints are used to set the net routing constraints of the desired auto-layout tool and any special layout constraints of the desired auto-layout tool are set with reference to the prior steps. The test-bench schematics of substep 26a and the constraints of substep 26b are used to generate necessary inputs of auto-layout tool 27b. The desired auto-layout tool is then run on sized schematic 29 in substep 27b, producing a final IC design layout which has the topology, sizing, and layout dictated by the specification 21b and the design format required by the designated forge as set forth in PDK 21a, and the method ends.

While auto-sizing tools and auto-layout tools are known in the art, they use very different technology and, absent the method of the invention, the inputs for both tools require a significant amount of manual work for preparation, and the output of one requires additional manipulation before being used as an input for the other. The technology synthesis module uses its platform-neutral modules and logic of expertise libraries to allow for a continuous automated process incorporating both technologies.

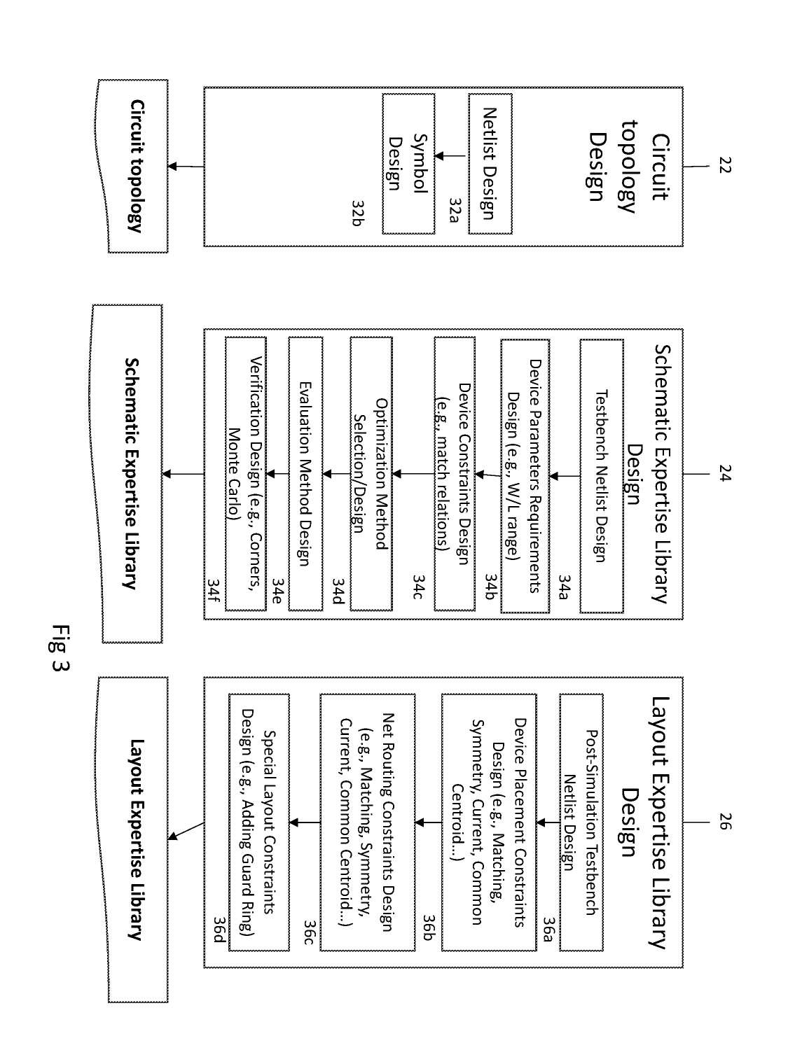

FIG. 3 shows the elements of the expertise libraries used to implement TSM 28 (Not shown, see FIG. 2.) Each expertise module contains one or more expertise modules. These expertise modules are “platform neutral,” in that they contain general-purpose libraries, logics, and lookup tables which are used in the intermediate design steps by TSM 28 to generate the inputs required by the auto-sizing and auto-layout tools in accord with specification 21b and PDK 21a. The listed components/sub-modules of each module are provided for illustration and are neither all required in any given implementation of the method nor an exclusive list of the components/sub-modules which must be present or not present in any given implementation.

Circuit topology design expertise library 22 includes a netlist design expertise module 32a which can convert netlist formats as required, and a symbol design expertise module 32b which can convert symbol formats as required.

Schematic design expertise library 24 includes a testbench netlist design expertise module 34a, a device parameters requirements design expertise module 24b, a device constraints design expertise module 34c, an optimization method selection/design expertise module 34d, an evaluation design expertise module 34e, and a verification design expertise module 34f.

Layout library design expertise module 26 includes post-simulation testbench netlist design expertise module 36a, device placement constraints design expertise module 36b, net routing constraints design expertise module 36c, and special layout constraints design expertise module 36d.

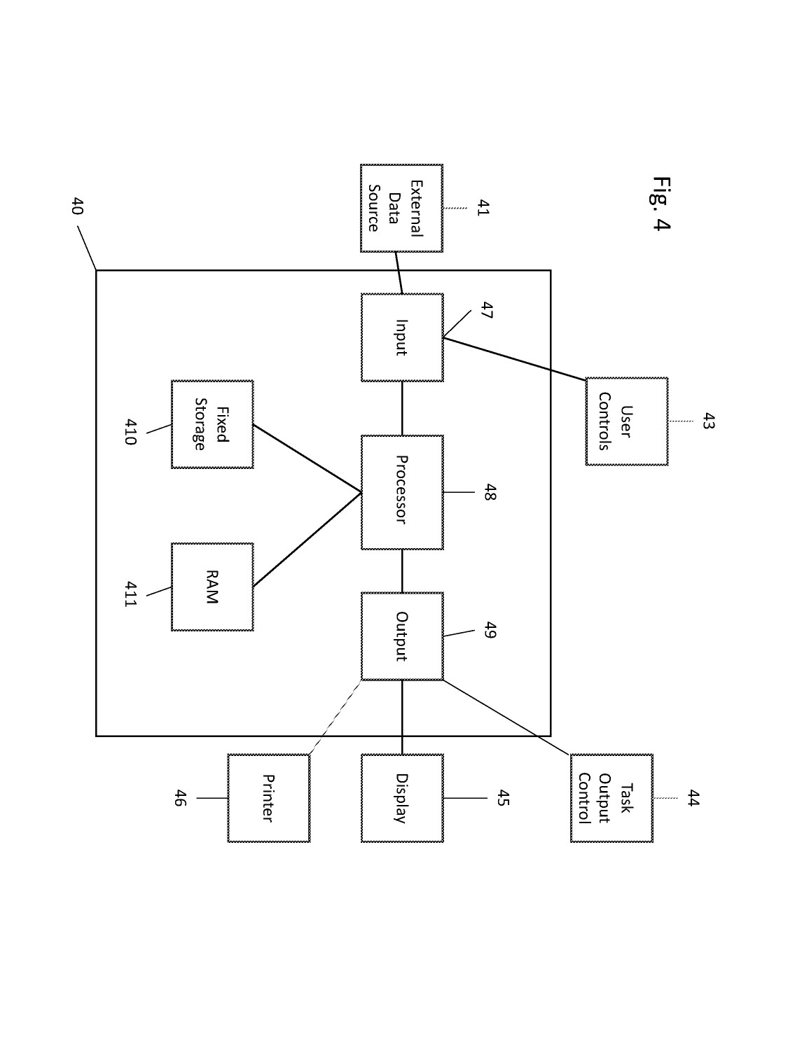

FIG. 4 shows the elements of a device implementing an aspect of the invention. Device 40 is a general purpose computer, but could also be a special-purpose computer, virtual machine, or other appropriate device or collection of connected devices.

Device 40 includes input bus 47, processor 48, output bus 49, fixed storage 410, and random access memory (“RAM”) 411. Input bus 47 and output bus 48 can be unified, for example as a SCSI bus, a USB bus, or any other reasonable combination of input and output bus technology. Processor 48 can be a general-purpose CPU or IC/VLSIC, or a special-purpose CPU, VPU, or other IC/VLSIC. Most of these components are well known in the art and can comprise any desired physical component, e.g. fixed storage 410 could comprise without limitation a hard disk drive, a flash drive, one or more read-only memory chips, a virtual drive connected by a network, or any combination thereof. In place of fixed storage 410 and RAM 411, a single unified memory device such as Flash RAM can be used.

Connected to device 40 is external data source 41, which could be a networked drive, a flash drive, an optical disk drive, or any other suitable data source or sources. External data source 41 is used to provide access to data such as the PDK for a designated forge, a specification file, or any other appropriate data. Task output control 44 allows for a completed IC design to be output (ultimately) to the designated foundry and/or forge which will produce the IC designed by the method. Display 45 and printer 46 allow the design or any other desired information to be displayed to a user, who uses user controls 43 to control the device and direct it in the implementation of the method.

After loading the PDK and the specification into fixed storage 410 and/or directly into RAM 411 from external data source 41 through input bus 47, they are processed with a stored instruction which applies the steps of the method of the invention as directed by the user, as described above in FIG. 2. The subcomponents of the expertise libraries are stored in fixed storage 410 and/or loaded into RAM 411 along with the logical code which implements the method. When the final IC design layout is complete, it is transmitted (ultimately) to the designated foundry and/or forge through task output control 44, and the forge produces the IC designed by the method. This transmission can take the form of an email, a text file, a direct transmission of a special-purpose file, or physical transfer such as on a flash drive.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for designing an integrated circuit integrating intellectual property modules comprising the steps of:
a) creating a specification for the integrated circuit, the specification comprising one or more input parameters, one or more output parameters, and one or more processing requirements;
b) obtaining a process design kit, the process design kit comprising one or more format requirements for an integrated circuit design file, the integrated circuit file being compatible with one or more integrated circuit forges;
c) creating a technology synthesis module which references a circuit topology expertise library, a schematic expertise library, a layout expertise library, the process design kit and the specification;
d) causing the technology synthesis module to reference the process design kit to obtain a preferred format for the integrated circuit forges; and
e) porting the specification to the preferred format of the designated forge with the technology synthesis module generating a final IC design layout which is in accord with the process design kit and the specification.

2. The method of claim 1, further comprising the steps of:
f) using the final IC design layout to produce an integrated circuit die; and
g) using the integrated circuit die to produce the integrated circuit.

3. The method of claim 1, wherein:
a) the circuit topology expertise library comprises a netlist of one or more sub-circuit modules and a netlist of one or more symbols of each sub-circuit module;
b) the schematic expertise library comprises one or more netlists of testbenches of a target IP, one or more device parameters requirements, one or more device constraints, one or more optimization methods wherein the optimization methods can be selected by and/or provided by an electronic design automation tool, one or more evaluation methods of the target IP and one or more design verification settings; and
c) the layout expertise library comprises one or more netlists of testbenches of target IP for post simulation, one or more device placement constraints, one or more net routing constraints, and one or more special layout constraints.

4. The method of claim 2, wherein:
h) the circuit topology expertise library comprises a netlist of one or more sub-circuit modules and a netlist of one or more symbols of each sub-circuit module;
i) the schematic expertise library comprises one or more netlists of testbenches of a target IP, one or more device parameters requirements, one or more device constraints, one or more optimization methods wherein the optimization methods can be selected by and/or provided by an electronic design automation tool, one or more evaluation methods of the target IP and one or more design verification settings; and
j) the layout expertise library comprises one or more netlists of testbenches of target IP for postsimulation, one or more device placement constraints, one or more net routing constraints, and one or more special layout constraints.

5. The method of claim 1, wherein the step of porting the specification to the preferred format of the designated forge with the technology synthesis module generating a final IC design layout comprises the steps of:
f) porting the specification to the preferred format of the designated forge with the technology synthesis module generating an unsized schematic;
g) causing the technology synthesis module to reference the process design kit to obtain one or more preferred test-bench schematics of the integrated circuit forge;
h) causing the technology synthesis module to generate one or more design variables required for the integrated circuit forge;
i) causing the technology synthesis module to reference one or more device constraints for an auto-sizing tool;
j) causing the technology synthesis module to reference one or more optimization methods for an auto-sizing tool;
k) causing the technology synthesis module to reference one or more evaluation methods for an auto-sizing tool;
l) causing the technology synthesis module to set a verification method of a target simulator for the integrated circuit;
m) causing the technology synthesis module to generate test-bench settings, parameters and constraints for the integrated circuit;
n) running the auto-sizing tool on the unsized schematic using the test-bench settings, parameters and constraints to generate a sized schematic;
o) causing the technology synthesis module to generate a second set of test-bench schematics to correspond with the sized schematic;
p) causing the technology synthesis module to set one or more device placement constraints of an auto-layout tool according to the requirements of the process design kit and the layout expertise library;
q) causing the technology synthesis module to set the net routing constraints of the auto-layout tool according to the device placement constraints;
r) causing the technology synthesis module to set one or more special layout constraints of the auto-layout tool with reference to the prior steps, if such special layout constraints are required by the process design kit or the auto-layout tool;
s) causing the technology synthesis module to generate a pre-layout schematic with reference to the prior steps; and
t) running the auto-layout tool on the pre-layout schematic to produce the final IC design layout in accord with the process design kit and the specification.

6. A method for designing an integrated circuit integrating intellectual property modules comprising the steps of:
a) designing a circuit topology expertise library, the circuit topology expertise library comprising a netlist of one or more sub-circuit modules and a netlist of one or more symbols of each sub-circuit module;
b) designing a schematic expertise library, the schematic expertise library comprising one or more netlists of testbenches of a target IP, one or more device parameters requirements, one or more device constraints, one or more optimization methods wherein the optimization methods can be selected by and/or provided by an electronic design automation tool, one or more evaluation methods of the target IP and one or more design verification settings;
c) designing a layout expertise library, the layout expertise library comprising one or more netlists of testbenches of target IP for post simulation, one or more device placement constraints, one or more net routing constraints, and one or more special layout constraints;
d) creating a specification for the integrated circuit, the specification comprising one or more input parameters, one or more output parameters, and one or more processing requirements;
e) obtaining a process design kit, the process design kit comprising one or more format requirements for an integrated circuit design file, the integrated circuit file being compatible with one or more integrated circuit forges;
f) creating a technology synthesis module which can reference the process design kit, the specification, the circuit topology expertise library, the schematic expertise library, and the layout expertise library;
g) causing the technology synthesis module to reference the process design kit to obtain a preferred format for the integrated circuit forges;
h) porting the specification to the preferred format of the designated forge with the technology synthesis module generating an unsized schematic;
i) causing the technology synthesis module to reference the process design kit to obtain one or more preferred test-bench schematics of the integrated circuit forge;
j) causing the technology synthesis module to use the preferred test-bench schematics to generate one or more design variables required for the integrated circuit forge;
k) causing the technology synthesis module to reference one or more device constraints for an auto-sizing tool;
l) causing the technology synthesis module to reference one or more optimization methods for an auto-sizing tool;
m) causing the technology synthesis module to reference one or more evaluation methods for an auto-sizing tool;
n) causing the technology synthesis module to set a verification method of a target simulator for the integrated circuit;
o) causing the technology synthesis module to generate test-bench settings, parameters and constraints for the integrated circuit;
p) running the auto-sizing tool on the unsized schematic using the test-bench settings, parameters and constraints to generate a sized schematic;
q) causing the technology synthesis module to generate a second set of test-bench schematics to correspond with the sized schematic;
r) causing the technology synthesis module to set one or more device placement constraints of an auto-layout tool according to the requirements of the process design kit and the layout expertise library;
s) causing the technology synthesis module to set the net routing constraints of the auto-layout tool according to the device placement constraints;
t) causing the technology synthesis module to set one or more special layout constraints of the auto-layout tool with reference to the prior steps, if such special layout constraints are required by the process design kit or the auto-layout tool;
u) causing the technology synthesis module to generate a pre-layout schematic with reference to the prior steps; and
v) running the auto-layout tool on the pre-layout schematic to produce a final IC design layout which is in accord with the process design kit and the specification.

7. A device for designing an integrated circuit integrating intellectual property modules comprising:
a) a processor which can execute an instruction;
b) a random access memory which can store the instruction;
c) an input bus which can accept an input and direct the input to the processor, the random access memory, and/or the fixed storage;
d) a fixed storage, the fixed storage containing:
i) a circuit topology expertise library,
ii) a schematic expertise library,
iii) a layout expertise library, and
iv) the instruction comprising the steps of:
1) accepting a specification for the integrated circuit;
2) accepting a process design kit;
3) running a technology synthesis module which can reference the process design kit and the specification, the technology synthesis module referencing the circuit topology expertise library, the schematic expertise library, and a layout process which can reference the layout expertise library;
4) causing the technology synthesis module to produce a final IC design layout which is in accord with the process design kit and the specification; and
5) outputting the final IC design layout through the output control bus for use with the integrated circuit forge.

8. The device of claim 7, wherein causing the technology synthesis module to produce a final IC design layout which is in accord with the process design kit and the specification further comprises:
porting the specification to the preferred format of the designated forge with the technology synthesis module generating an unsized schematic;
causing the technology synthesis module to reference the process design kit to obtain one or more preferred test-bench schematics of the integrated circuit forge;
causing the technology synthesis module to use the preferred test-bench schematics to generate the general device parameters required for the integrated circuit forge;
causing the technology synthesis module to reference one or more device constraints for an auto-sizing tool;
causing the technology synthesis module to reference one or more optimization methods for an auto-sizing tool;
causing the technology synthesis module to reference one or more evaluation methods for an auto-sizing tool;
causing the technology synthesis module to set a verification method of a target simulator for the integrated circuit;
causing the technology synthesis module to generate test-bench settings, parameters and constraints for the integrated circuit;
running the auto-sizing tool on the unsized schematic using the test-bench settings, parameters and constraints to generate a sized schematic;
causing the technology synthesis module to either re-use the test-bench schematics as a current test-bench schematics or to re-generate the test-bench schematics as the current test-bench schematics to correspond with the sized schematic;
causing the technology synthesis module to set one or more device placement constraints of an auto-layout tool according to the requirements of the process design kit and the layout expertise library;
causing the technology synthesis module to set the net routing constraints of the auto-layout tool according to the device placement constraints;
causing the technology synthesis module to set one or more special layout constraints of the auto-layout tool with reference to the prior steps, if such special layout constraints are required by the process design kit or the auto-layout tool;
causing the technology synthesis module to generate a pre-layout schematic with reference to the prior steps; and
running the auto-layout tool on the pre-layout schematic to produce the final IC design layout in accord with the process design kit and the specification.

9. The device of claim 7, wherein:
a) the circuit topology expertise library comprises a netlist of one or more sub-circuit modules and a netlist of one or more symbols of each sub-circuit module;
b) the schematic expertise library comprises one or more netlists of testbenches of a target IP, one or more device parameters requirements, one or more device constraints, one or more optimization methods wherein the optimization methods can be selected by and/or provided by an electronic design automation tool, one or more evaluation methods of the target IP and one or more design verification settings; and
c) the layout expertise library comprises one or more netlists of testbenches of target IP for post simulation, one or more device placement constraints, one or more net routing constraints, and one or more special layout constraints.

10. The device of claim 8, wherein:
a) the circuit topology expertise library comprises a netlist of one or more sub-circuit modules and a netlist of one or more symbols of each sub-circuit module;
b) the schematic expertise library comprises one or more netlists of testbenches of a target IP, one or more device parameters requirements, one or more device constraints, one or more optimization methods wherein the optimization methods can be selected by and/or provided by an electronic design automation tool, one or more evaluation methods of the target IP and one or more design verification settings; and
c) the layout expertise library comprises one or more netlists of testbenches of target IP for post simulation, one or more device placement constraints, one or more net routing constraints, and one or more special layout constraints.

11. The method of claim 1, wherein the TSM acts as a parsing module which reads and then synthesizes a complete set of input files for running an auto-sizing tool and an auto-layout tool, the complete set of input files including at least one circuit diagram, at least one configuration, at least one design parameter, and at least one test-bench.

12. The method of claim 6, wherein the TSM acts as a parsing module which reads and then synthesizes a complete set of input files for running an auto-sizing tool and an auto-layout tool, the complete set of input files including at least one circuit diagram, at least one configuration, at least one design parameter, and at least one test-bench.

13. The device of claim 7, wherein the TSM acts as a parsing module which reads and then synthesizes a complete set of input files for running an auto-sizing tool and an auto-layout tool, the complete set of input files including at least one circuit diagram, at least one configuration, at least one design parameter, and at least one test-bench.

14. The device of claim 9, wherein the TSM acts as a parsing module which reads and then synthesizes a complete set of input files for running an auto-sizing tool and an auto-layout tool, the complete set of input files including at least one circuit diagram, at least one configuration, at least one design parameter, and at least one test-bench.
